(19) United States
(12) Patent Application Publication
(10) Pub. No.: US 2026/0131284 A1
(43) Pub. Date: May 14, 2026

(54) THREE-WAY CATALYST AND METHOD FOR MANUFACTURING THE SAME

(71) Applicants: Masahide MIURA, Toyota-shi (JP); Masaya KAMADA, Toyota-shi (JP); Takeshi HIRABAYASHI, Toyota-shi (JP); Shogo SHIRAKAWA, Toyota-shi (JP); Naoki KUMATANI, Nagakute-shi (JP); Akira MORIKAWA, Nagakute-shi (JP); Miho HATANAKA, Nagakute-shi (JP); Takuya OKUDA, Hamamatsu-shi (JP); Tsubasa NANJO, Toyota-shi (JP); Tomoka YAMAMOTO, Iwata-shi (JP)

(72) Inventors: Masahide MIURA, Toyota-shi (JP); Masaya KAMADA, Toyota-shi (JP); Takeshi HIRABAYASHI, Toyota-shi (JP); Shogo SHIRAKAWA, Toyota-shi (JP); Naoki KUMATANI, Nagakute-shi (JP); Akira MORIKAWA, Nagakute-shi (JP); Miho HATANAKA, Nagakute-shi (JP); Takuya OKUDA, Hamamatsu-shi (JP); Tsubasa NANJO, Toyota-shi (JP); Tomoka YAMAMOTO, Iwata-shi (JP)

(73) Assignees: TOYOTA JIDOSHA KABUSHIKI KAISHA, Toyota-shi (JP); KABUSHIKI KAISHA TOYOTA CHUO KENKYUSHO, Nagakute-shi (JP); CATALER CORPORATION, Kakegawa-shi (JP)

(21) Appl. No.: 19/370,263

(22) Filed: Oct. 27, 2025

(30) Foreign Application Priority Data
Nov. 8, 2024 (JP) 2024-195853

(51) Int. Cl. B01D 53/94; B01J 21/06; B01J 23/02; B01J 23/38; B01J 35/70; B01J 37/04

(52) U.S. Cl. CPC B01D 53/945; B01J 21/066; B01J 23/02; B01J 23/38; B01J 35/733; B01J 37/04; B01D 2255/908; B01D 2257/404; B01D 2257/502; B01D 2257/702

(57) ABSTRACT

Provided is a heat-resistant three-way catalyst having a catalyst performance and an OSC performance in a compatible manner, and a method for manufacturing the same. Some aspects of the present disclosure relate to a three-way catalyst and a method for manufacturing the same. The three-way catalyst includes a noble metal, an OSC material, and an oxide solid solution comprising barium and zirconium. The noble metal is supported on the OSC material. A mole ratio of barium to zirconium (Ba:Zr) in the oxide solid solution is in a range of 20:80 to 49:51. A content of barium carbonate and barium oxide in the oxide solid solution is 2 weight % or less.

### CROSS REFERENCE TO RELATED APPLICATIONS

The present application claims priority from Japanese patent application JP 2024-195853 filed on Nov. 8, 2024, the entire content of which is hereby incorporated by reference into this application.

### BACKGROUND

### Technical Field

Some aspects of the present disclosure relate to a three-way catalyst and a method for manufacturing the same.

### Background Art

An exhaust gas discharged from an internal combustion engine for an automobile and the like, for example, an internal combustion engine, such as a gasoline engine or a diesel engine, comprises harmful components, such as carbon monoxide (CO), hydrocarbon (HC), and nitrogen oxides (NOx).

Therefore, the internal combustion engine generally includes an exhaust gas purification device to decompose and remove these harmful components, and the harmful components are made almost detoxified by an exhaust gas purification catalyst, for example, a three-way catalyst, disposed in the exhaust gas purification device.

The three-way catalyst comprises a noble metal, and the noble metal functions to simultaneously promote oxidation reactions of CO and HC and a reduction reaction of NOx. The noble metal is expensive, and further, required to be reduced from the aspect of resource risk. To reduce the noble metal amount, it is only necessary to avoid reduction of catalytic activity of the noble metal by using an exhaust gas purification catalyst, and to avoid the reduction of the catalytic activity of the noble metal, for example, it is considered to suppress poisoning (HC poisoning) of the noble metal by HC in the exhaust gas as one factor of the reduction of the catalytic activity of the noble metal.

For example, JP 2010-12459 A discloses an exhaust gas purification catalyst in which an active metal is supported on a carrier comprising BaAl₂O₄ and BaZrO₃.

JP 2013-39520 A discloses a mixed catalyst that includes a catalyst A with an active metal a on a surface of a carrier a comprising Ba, Al, and Zr and an oxide thereof as main components and a catalyst B with an active metal β on a surface of a carrier b comprising cerium oxide as a main component, in which a ratio of a mass of the catalyst A to a total mass of the catalyst A and the catalyst B (A/(A+B)×100) is more than 10 mass % and less than 80 mass %.

JP 2020-54982 A discloses an exhaust gas purification catalyst that is disposed at an exhaust pipe of an internal combustion engine and purifies an exhaust gas discharged from the internal combustion engine. The exhaust gas purification catalyst includes a substrate and a catalyst layer formed on the substrate. The catalyst layer has an alkaline-earth metal carrying region including a porous carrier constituted of an inorganic compound, Pt carried on the porous carrier, and a sulfuric acid salt of at least one alkaline-earth metal carried on the porous carrier, wherein a value of R_{Ae/Pt} is 0.5 or more, where R_{Ae/Pt} represents the Pearson's correlation coefficient calculated using α and β in each pixel obtained by, for a cross section of the alkaline-earth metal carrying region of the catalyst layer, performing the area analysis by FE-EPMA under the conditions of: pixel size 0.34 μm×0.34 μm; and number of measured pixels 256×256; and measuring an intensity (α: cps) of a characteristic X-ray of an element (Ae) of the alkaline-earth metal and an intensity (β: cps) of a characteristic X-ray of Pt for each pixel.

WO 2020/195600 discloses an exhaust gas purification catalyst that comprises a perovskite-type complex oxide formed of at least Ba, Zr, Y, and Pd.

### SUMMARY

Meanwhile, the three-way catalyst is required to have an oxygen storage capacity (OSC), and the three-way catalyst possibly includes a material having the OSC (OSC material) besides the catalyst metal. The “OSC material” is a material that can absorb and release oxygen. The OSC material allows keeping an oxygen concentration constant to maintain a purification performance (catalyst performance) of the three-way catalyst even when an air-fuel ratio varies.

That is, as a three-way catalyst, a three-way catalyst having a catalyst performance, that is, suppressing HC poisoning of a noble metal, and an OSC performance in a compatible manner is desired.

However, in a palladium (Pd)-based three-way catalyst, an alkaline-earth metal that can be introduced to suppress HC poisoning and improve a low-temperature activity of the noble metal, for example, barium (Ba), such as barium sulfate and barium carbonate, moves in a catalyst coat layer under a specific high-temperature condition, and further undergoes a solid-state reaction with an OSC material, for example, CeO₂—ZrO₂ solid solution (CZ), in some cases, resulting in a decrease in the OSC performance. This is considered to be caused by Ba supported on a surface layer of the carrier reacting with the OSC material in the vicinity at high temperature, thereby reducing crystallinity of the OSC material. Free barium carbonate promotes reduction in the specific surface area of the carrier and/or substrate and the covering of the noble metal, thus reducing the purification activity in some cases.

Accordingly, some aspects of the present disclosure provide a high heat-resistant three-way catalyst having a catalyst performance and an OSC performance in a compatible manner, and a method for manufacturing the same.

The inventors examined various means to solve the problem. The inventors found that by using a BaZrOx-based composite oxide (BZ) as a Ba additive in a three-way catalyst, the three-way catalyst becomes thermally stable compared with the use of BaCO₃, BaO, and BaSO₄, which are conventionally used as a Ba additive, and further, the three-way catalyst becomes not less likely to form BaCO₃ even in the use at high temperature, consequently, the three-way catalyst can have an OSC performance and a purification activity, especially a purification activity at low temperature after a heat resistance test of the three-way catalyst in a compatible manner. Furthermore, the inventors found that by limiting a ratio of Ba to Zr to a specific range in a composition and a structure of BZ, stability of a perovskite structure increases compared with a BaZrMO₃-based composite oxide (in the formula, M is, for example, Y, Pd, Ce or the like) having the similar structure, and generation of unstable BaCO₃ and BaO can be suppressed. Thus, the inventors completed some aspects of the present disclosure.

That is, the gist of some aspects of the present disclosure is as follows.
(1) A three-way catalyst comprises a noble metal, an OSC material, and an oxide solid solution comprising barium and zirconium. The noble metal is supported on the OSC material. A mole ratio of barium to zirconium (Ba:Zr) in the oxide solid solution is in a range of 20:80 to 49:51. A content of barium carbonate and barium oxide in the oxide solid solution is 2 weight % (% by weight) or less with respect to a total weight of the oxide solid solution.
(2) In the three-way catalyst according to (1), the oxide solid solution is a perovskite-type oxide.
(3) In the three-way catalyst according to (1) or (2), the mole ratio of barium to zirconium (Ba:Zr) in the oxide solid solution is in a range of 30:70 to 49:51.
(4) In the three-way catalyst according to any one of (1) to (3), the content of barium carbonate and barium oxide in the oxide solid solution is 1 weight % or less.
(5) A method for manufacturing a three-way catalyst, comprising: (i) preparing an oxide solid solution comprising barium and zirconium by coprecipitating barium and zirconium from an aqueous solution comprising a barium compound and a zirconium compound to obtain a precipitate and firing the precipitate at a temperature from 1000° C. to 1400° C., wherein a mole ratio of barium to zirconium (Ba:Zr) in the oxide solid solution is adjusted in a range of 20:80 to 49:51; (ii) preparing a noble metal-supported OSC material by mixing an aqueous solution containing a noble metal and an OSC material to obtain a mixture and drying the mixture; and (iii) producing a three-way catalyst by mixing the oxide solid solution prepared in (i) and the noble metal-supported OSC material prepared in (ii).

Some aspects of the present disclosure provides the high heat-resistant three-way catalyst having the catalyst performance and the OSC performance in a compatible manner, and the method for manufacturing the same.

### BRIEF DESCRIPTION OF THE DRAWINGS

FIG. 1 is a drawing illustrating configurations of three-way catalysts including schematic diagrams for comparing three-way catalysts of Comparative Examples 1 to 6 and three-way catalysts of Examples 1 to 5;

FIG. 2 is a drawing illustrating powder X-ray diffraction patterns of respective Ba additives used in Examples and Comparative Examples;

FIG. 3 is a graph indicating a relation between a Ba/Zr mole ratio and an amount of barium carbonate and barium oxide with respect to the Ba additives in the three-way catalysts of Examples and Comparative Examples, “E” indicates Example, and “C” indicates Comparative Example; and

FIG. 4 is a graph indicating a relation between an OSC amount at 500° C. and HC-T50 in the three-way catalysts of Examples and Comparative Examples, “E” indicates Example, and “C” indicates Comparative Example.

### DETAILED DESCRIPTION

The following describes embodiments in some aspects of the present disclosure in detail.

In this description, features in some aspects of the present disclosure are described with reference to the drawings as necessary. In the drawings, for clarification, dimensions and shapes of respective components are exaggerated, and actual dimensions and shapes are not precisely illustrated. The technical scope of some aspects of the present disclosure is not limited to the dimensions or the shapes of the respective components illustrated in these drawings. Note that a three-way catalyst and a method for manufacturing the sane in some aspects of the present disclosure are not limited to the embodiments below, and can be performed in various configurations in which changes, improvements, and the like that a person skilled in the art can make are given without departing from the gist of some aspects of the present disclosure.

A three-way catalyst in some aspects of the present disclosure comprises a noble metal, an OSC material, and an oxide solid solution comprising barium and zirconium.

The noble metal is not limited insofar as the noble metal acts as a catalyst metal. Examples of the noble metal include aurum (Au), argentum (Ag), platinum (Pt), palladium (Pd), rhodium (Rh), ruthenium (Ru), osmium (Os), iridium (Ir), a mixture of two or more thereof, and the like. The noble metal may be an alloy containing two or more elements including the above-described elements. In one embodiment, the noble metal is Pt, Pd, and/or Rh. In one embodiment, the noble metal is Pd.

An average particle diameter of the noble metal is not limited. The average particle diameter of the noble metal is ordinarily 0.1 nm to 100 nm, and 1 nm to 50 nm in one embodiment, as a projected area circle equivalent diameter (Haywood diameter) of a transmission electron microscope (TEM).

A content of the noble metal is not limited. The content of the noble metal is ordinarily 0.1 weight % to 20 weight %, and 0.5 weight % to 10 weight % in one embodiment in a noble metal conversion with respect to the total weight of the three-way catalyst. The contents of the components, such as a noble metal, an OSC material, and an oxide solid solution comprising barium and zirconium, comprised in the three-way catalyst usually depend on additive amounts of respective component precursors as materials at the manufacture of the three-way catalyst.

By setting the kind, the average particle diameter, and the content of the noble metal as described above, the catalyst performance of the three-way catalyst can be sufficiently ensured.

The OSC material is not limited insofar as the OSC material has an OSC performance. Examples of the OSC material include ceria (CeO₂), alumina (Al₂O₃)-ceria-zirconia (ZrO₂)-based composite oxides (ACZ), ceria-zirconia-based composite oxides (CZ), such as a ceria-zirconia-based composite oxide having a fluorite structure (CeZrO₄) and a ceria-zirconia-based composite oxide having a pyrochlore structure (Ce₂Zr₂O₇). A component ratio of elements constituting the OSC material is not limited, and further, the OSC material may comprise additive elements, for example, praseodymium (Pr), scandium (Sc), yttrium (Y), lanthanum (La), neodymium (Nd), samarium (Sm), gadolinium (Gd), terbium (Tb), dysprosium (Dy), ytterbium (Yb), lutetium (Lu), titanium (Ti), a mixture of two or more thereof, and the like.

An average particle diameter of the OSC material is not limited. An average primary particle diameter of the OSC material is ordinarily 1 nm to 50 nm, and an average secondary particle diameter is 0.1 m to 50 m, and 1 m to 25 m in one embodiment as a projected area circle equivalent diameter (Haywood diameter) of a transmission electron microscope (TEM) or a scanning electron microscope (SEM).

Although not limited, a content of the OSC material is ordinarily 5 weight % to 80 weight %, and 10 weight % to 70 weight % in one embodiment with respect to the total weight of the three-way catalyst.

By setting the kind, the average particle diameter, and the content of the OSC material as described above, the OSC performance of the three-way catalyst can be sufficiently ensured.

The oxide solid solution comprising barium and zirconium is also expressed as a BaZrOx-based composite oxide or BZ, specifically, comprises a composite oxide having a BaZrO₃-type perovskite structure and comprises partially monoclinic, tetragonal, and cubic ZrO₂, and an atomic molar ratio of barium to zirconium (Ba:Zr) comprised in the BaZrOx-based composite oxide is adjusted to fall within a range of 20:80 to 49:51, and within a range of 30:70 to 49:51 in one embodiment.

In the oxide solid solution comprising barium and zirconium, the content of barium carbonate (BaCO₃) and barium oxide (BaO) is 2 weight % or less, 1.5 weight % or less in one embodiment, and 1 weight % or less in one embodiment with respect to the total weight of the oxide solid solution. Since BaCO₃ and BaO do not need to be present, the lower limit value of the content of BaCO₃ and BaO is not limited.

Since the oxide solid solution comprising barium and zirconium is present with the mole ratio of barium to zirconium in the above-described range, the content of BaCO₃ and BaO can be maintained in the above-described range without generating BaCO₃ and BaO in the oxide solid solution even under a high-temperature atmosphere, thereby allowing the perovskite structure to be kept stable. Consequently, the three-way catalyst can maintain both the purification activity and the OSC performance to be high.

An average particle diameter of the oxide solid solution comprising barium and zirconium is not limited. An average primary particle diameter of the oxide solid solution comprising barium and zirconium is ordinarily 10 nm to 80 nm, and 1 nm to 50 nm in one embodiment as a projected area circle equivalent diameter (Haywood diameter) of a transmission electron microscope (TEM).

Although not limited, a content of the oxide solid solution comprising barium and zirconium is ordinarily 5 weight % to 40 weight %, and 8 weight % to 30 weight % in one embodiment with respect to the total weight of the three-way catalyst.

By setting the average particle diameter and the content of the oxide solid solution comprising barium and zirconium as described above, HC poisoning of the noble metal can be sufficiently suppressed by barium.

The three-way catalyst in some aspects of the present disclosure may further comprise other components in a range not impairing an effect of some aspects of the present disclosure.

The other components may include metal oxides, additives, and the like used in three-way catalysts for such applications. Examples include metal oxides, such as silica, magnesium oxide (MgO), zirconia, alumina, titania (TiO₂), yttria (Y₂O₃), neodymium oxide (Nd₂O₃), and lanthanum oxide (La₂O₃), composite oxides and solid solutions thereof, such as an alumina-zirconia-based composite oxide (AZ), alkali metals, such as potassium (K), sodium (Na), lithium (Li), and cesium (Cs), alkaline-earth metals other than Ba, such as calcium (Ca) and strontium (Sr), rare earth elements, such as La, Y, and Ce, transition metals, such as iron (Fe), and combinations of two or more thereof. Proportions of respective oxides in the composite oxide, for example, AZ are not limited, and proportions generally used in the technical field of the three-way catalyst may be used.

Although a content of the other components is not limited, when the other components are present, the content is ordinarily 5 weight % to 70 weight %, and 10 weight % to 50 weight % in one embodiment with respect to the total weight of the three-way catalyst.

An acidic carrier, for example, silica is compatible with a catalyst metal that reduces NOx. A basic carrier, for example, magnesium oxide is compatible with potassium and barium that occlude NOx. Zirconia can suppress sintering of other carrier particles at a high temperature at which sintering of the other carrier particles causes, and zirconia can cause a steam reforming reaction to generate H₂ by a combination with Rh as the noble metal, thus allowing efficiently reducing NOx. An acid-base amphoteric carrier, for example, alumina has a high specific surface area, and therefore, can be used for efficient occlusion and reduction of NOx. Titania can provide an effect of suppressing sulfur poisoning of the catalyst metal. Adding alumina, zirconia, and the other metal oxide enables enhancing durability of the carrier.

The main carrier of the noble metal comprised in the three-way catalyst in some aspects of the present disclosure is the OSC material, and a part of the noble metal may be supported on also an Al₂O₃-based oxide carrier comprised in the three-way catalyst. By supporting the noble metal on the OSC material, an oxygen absorption/release performance is sufficiently provided, and the high specific surface area can be ensured as a supporting site of the noble metal, consequently, the high catalyst performance can be ensured.

The three-way catalyst in some aspects of the present disclosure can be used in a pellet shape by being filled in a reaction tube and the like.

Furthermore, the three-way catalyst in some aspects of the present disclosure may have a configuration including a substrate and a catalyst coat layer coated over the substrate in consideration of practical use. The three-way catalyst in some aspects of the present disclosure may be used with the noble metal, the OSC material, the oxide solid solution comprising barium and zirconium, and the optional other component as described above introduced to the catalyst coat layer.

When such a configuration of the three-way catalyst is employed, a publicly known substrate having a honeycomb shape can be used for the substrate. For the substrate, specifically, a honeycomb-shaped monolith substrate (honeycomb filter, high density honeycomb, and the like) and the like can be used. Materials of the substrate is also not especially limited. Examples of the substrate include substrates made of ceramic, such as cordierite, silicon carbide (SiC), silica (SiO₂), alumina, and mullite, or a mixture thereof, and substrates made of a metal, such as stainless steel comprising chromium and aluminum. In one embodiment, from the perspective of cost, the substrate is made of cordierite.

Although not limited, a coat amount of the catalyst coat layer is ordinarily 100 g to 300 g, and 150 g to 250 g in one embodiment with respect to a capacity of 1 L of a part applied with the catalyst coat layer in the substrate.

Although not limited, a thickness of the catalyst coat layer is ordinarily 50 m to 200 m, and 80 m to 150 m in one embodiment as an average thickness. The thickness of the catalyst coat layer can be measured by for example, a scanning electron microscope (SEM).

The coat amount and the thickness of the catalyst coat layer in the above-described ranges allows properly keeping a balance between a pressure loss, the catalyst performance, and durability in the three-way catalyst.

Some aspects of the present disclosure further relate to a method for manufacturing the three-way catalyst in some aspects of the present disclosure.

The three-way catalyst in some aspects of the present disclosure can be manufactured by a method including (i) a step of preparing an oxide solid solution comprising barium and zirconium by coprecipitating barium and zirconium from an aqueous solution comprising a zirconium compound and a barium compound to obtain a precipitate and firing the precipitate at a specific temperature, wherein a mole ratio of barium to zirconium (Ba:Zr) in the oxide solid solution is adjusted in the above-described range, (ii) a step of preparing a noble metal-supported OSC material by mixing an aqueous solution containing the noble metal and an OSC material to obtain first mixture and drying the first mixture, and (iii) a step of producing a three-way catalyst by mixing the oxide solid solution prepared in (i) and the noble metal-supported OSC material prepared in (ii) to obtain second mixture and optionally, firing the second mixture at a specific temperature.

In the step (i), the type and the concentration of the zirconium compound and the barium compound are not limited insofar as the zirconium compound and the barium compound are dissolved in water as a solvent and the mole ratio of barium to zirconium is within the above-described range. Examples of the zirconium compound and the barium compound include acetate, nitrate, sulfate, and halide, such as fluoride, chloride, and bromide. Each concentration of zirconium or barium in the aqueous solution comprising the zirconium compound and the barium compound is ordinarily in a range of 0.1 mol/L or more and 1.0 mol/L or less.

In the step (i), the method for coprecipitating barium and zirconium from the aqueous solution comprising the zirconium compound and the barium compound is not limited. Examples of the coprecipitating method include a method of mixing the aqueous solution comprising the zirconium compound and the barium compound and acid or base, a method of adding the aqueous solution comprising the zirconium compound and the barium compound to acid or base, a method of adding acid or base to the aqueous solution comprising the zirconium compound and the barium compound, a method of simultaneously adding the aqueous solution comprising the zirconium compound and the barium compound and acid or base in water, and the like. The acid or base is not limited. Examples of acid include hydrochloric acid, sulfuric acid, nitric acid, acetic acid, a mixture of two or more thereof, and the like. Examples of base include sodium hydroxide, potassium hydroxide, ammonia, ammonium carbonate, ammonium hydrogen carbonate, a mixture of two or more thereof, and the like. Although not limited, the reaction temperature is ordinarily 20° C. to 100° C., 20° C. to 60° C. in one embodiment, and 20° C. to 40° C. in one embodiment. Although not limited, a reaction time is ordinarily 5 minutes to 2 hours, 10 minutes to 1 hour in one embodiment, and 20 minutes to 40 minutes in one embodiment.

The mixture comprising barium and zirconium obtained by coprecipitation may be dried as necessary, for example, ordinarily at 100° C. to 180° C. ordinarily for 1 hour to 10 hours, and fired, for example, at ordinarily 300° C. to 500° C. ordinarily for 1 hour to 8 hours.

The mixture comprising barium and zirconium is subsequently fired at 1000° C. to 1400° C., and 1100° C. to 1200° C. in one embodiment for ordinarily 1 hour to 20 hours, and 10 hours to 18 hours in one embodiment.

By firing the mixture comprising barium and zirconium at a high temperature equal to or more than 1000° C., the mixture comprising barium and zirconium becomes the oxide solid solution comprising barium and zirconium, that is, a perovskite-type oxide.

In the step (ii), the noble metal, OSC material, and other component as described above are mixed to obtain first mixture.

The mixing method is not limited. For the mixing method, for example, a method in which an aqueous solution comprising the dissolved noble metal is impregnated into the OSC material or the OSC material is added to the aqueous solution comprising the dissolved noble metal, and the resulting material is further mixed can be used.

The mixture (first mixture) of the noble metal and the OSC material mixed in the step (ii) is dried as necessary, for example, ordinarily at 100° C. to 220° C. ordinarily for 1 hour to 15 hours, and further fired specifically at 400° C. to 800° C., and 400° C. to 600° C. in one embodiment, ordinarily for 1 hour to 5 hours, and thus, the noble metal-supported OSC material is produced.

In the step (iii), the oxide solid solution comprising barium and zirconium prepared in the step (i), the noble metal-supported OSC material prepared in the step (ii), and the other component are mixed to obtain second mixture.

The mixing method is not limited. Examples of the mixing method include a dry blending and/or a wet blending.

The obtained mixture (second mixture) is pulverized, and formed or molded as necessary, thus the three-way catalyst is produced.

In the step (iii), a three-way catalyst including a substrate and a catalyst coat layer coated over the substrate may be produced by mixing the oxide solid solution comprising barium and zirconium prepared in the step (i) and the noble metal-supported OSC material prepared in the step (ii) in a solvent, for example, water to produce a catalyst coat layer slurry, applying the catalyst coat layer slurry over a wall surface of the above-described substrate, then drying the slurry, for example, ordinarily at 100° C. to 120° C. ordinarily for 1 hour to 3 hours, and further firing the slurry specifically at 400° C. to 800° C., 400° C. to 600° C. in one embodiment, and 300° C. to 500° C. in one embodiment, ordinarily for 1 hour to 3 hours.

In the steps (i) and (ii), the above-described conditions, especially the conditions other than the firing temperature in the step (i) are not limited. For example, the firing atmosphere may be in air or in an inert gas, for example, nitrogen gas and/or noble gas, such as argon gas.

(Usage of Three-Way Catalyst) The three-way catalyst in some aspects of the present disclosure can provide a large effect in the exhaust gas purification performance in a rich atmosphere, and can be used as a heat-resistant three-way catalyst highly effective in suppressing HC poisoning, which can be used even in an environment in which excess HC and the like are absorbed on the three-way catalyst to possibly poison the three-way catalyst in the rich atmosphere.

### Examples

The following describes some examples related to some aspects of the present disclosure, but it is not intended to limit some aspects of the present disclosure to the examples.

### 1. Three-Way Catalyst Preparation

### Example 1 (BZ48/52)

12.26 g of barium acetate was dissolved in 100 g of ion-exchanged water and stirred for 15 minutes or more, thereby preparing a barium acetate aqueous solution. Subsequently, 20.67 g of 25% ammonia aqueous solution and 29.21 g of ammonium carbonate were dissolved in 200 g of ion-exchanged water and stirred for 15 minutes or more, thereby preparing an aqueous solution of ammonia and ammonium carbonate. Further, 35.60 g of zirconyl nitrate aqueous solution was dissolved in 100 g of ion-exchanged water and stirred for 15 minutes or more, thereby preparing a zirconyl nitrate aqueous solution.

Subsequently, the barium acetate aqueous solution and the zirconyl nitrate aqueous solution were mixed, and the resulting mixed aqueous solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1100° C. for 15 hours, thereby obtaining BaZrOx (Ba:Zr=48:52 mole ratio) powder (Ba additive). The resulting powder was ground and classified to be 25 μm or less using a mortar and a sieve.

Subsequently, 15.00 g of Al₂O₃—CeO₂—ZrO₂-based composite oxide (Al₂O₃:CeO₂:ZrO₂:La₂O₃:Y₂O₃=30:27:35:4:4 (weight ratio), hereinafter referred to as ACZ) was immersed in a palladium aqueous solution prepared by dissolving 1.83 g of palladium nitrate aqueous solution (equivalent to 8.2 weight %-Pd) in 50 g of ion-exchanged water, and dried at 200° C. while stirring with a hot stirrer. Then, the resulting material was dried at 110° C. overnight, fired in air at 500° C. for 3 hours, thereby obtaining a Pd-supported ACZ catalyst. The resulting catalyst was ground and classified to be 25 μm or less using a mortar and a sieve.

Subsequently, 12.0 g of the ground Pd-supported ACZ and 2.0 g of the ground BaZrOx powder were ground and mixed for 5 minutes or more using a mortar. The mixed powder was formed by 1-ton isostatic pressing, and classified using α sieve into pellets with a diameter of 0.5 mm to 1.0 mm, thereby obtaining an initial catalyst.

### Example 2 (BZ45/55)

A catalyst was prepared similarly to Example 1 except that BaZrOx (Ba:Zr=45:55 mole ratio) powder obtained as described below was used instead of BaZrOx (Ba:Zr=48:52 mole ratio) powder in Example 1.

11.51 g of barium acetate was dissolved in 100 g of ion-exchanged water and stirred for 15 minutes or more, thereby preparing a barium acetate aqueous solution. Subsequently, 21.12 g of 25% ammonia aqueous solution and 29.83 g of ammonium carbonate were dissolved in 100 g of ion-exchanged water and stirred for 15 minutes or more, thereby preparing an aqueous solution of ammonia and ammonium carbonate. Further, 37.71 g of zirconyl nitrate aqueous solution was dissolved in 100 g of ion-exchanged water and stirred for 15 minutes or more, thereby preparing a zirconyl nitrate aqueous solution.

Subsequently, the barium acetate aqueous solution and the zirconyl nitrate aqueous solution were mixed, and the resulting mixed aqueous solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1100° C. for 15 hours, thereby obtaining BaZrOx (Ba:Zr=45:55 mole ratio) powder.

### Example 3 (BZ40/60)

A catalyst was prepared similarly to Example 1 except that BaZrOx (Ba:Zr=40:60 mole ratio) powder obtained as described below was used instead of BaZrOx (Ba:Zr=48:52 mole ratio) powder in Example 1.

10.35 g of barium acetate was dissolved in 100 g of ion-exchanged water and stirred for 15 minutes or more, thereby preparing a barium acetate aqueous solution. Subsequently, 22.04 g of 25% ammonia aqueous solution and 31.14 g of ammonium carbonate were dissolved in 100 g of ion-exchanged water and stirred for 15 minutes or more, thereby preparing an aqueous solution of ammonia and ammonium carbonate. Further, 41.60 g of zirconyl nitrate aqueous solution was dissolved in 100 g of ion-exchanged water and stirred for 15 minutes or more, thereby preparing a zirconyl nitrate aqueous solution.

Subsequently, the barium acetate aqueous solution and the zirconyl nitrate aqueous solution were mixed, and the resulting mixed aqueous solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1100° C. for 15 hours, thereby obtaining BaZrOx (Ba:Zr=40:60 mole ratio) powder.

### Example 4 (BZ30/70)

A catalyst was prepared similarly to Example 1 except that BaZrOx (Ba:Zr=30:70 mole ratio) powder obtained as described below was used instead of BaZrOx (Ba:Zr=48:52 mole ratio) powder in Example 1.

7.66 g of barium acetate was dissolved in 100 g of ion-exchanged water and stirred for 15 minutes or more, thereby preparing a barium acetate aqueous solution. Subsequently, 23.12 g of 25% ammonia aqueous solution and 32.67 g of ammonium carbonate were added to 100 g of ion-exchanged water and stirred for 15 minutes or more, thereby preparing an aqueous solution of ammonia and ammonium carbonate. Further, 47.92 g of zirconyl nitrate aqueous solution was dissolved in 100 g of ion-exchanged water and stirred for 15 minutes or more, thereby preparing a zirconyl nitrate aqueous solution.

Subsequently, the barium acetate aqueous solution and the zirconyl nitrate aqueous solution were mixed, and the resulting mixed aqueous solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1100° C. for 15 hours, thereby obtaining BaZrOx (Ba:Zr=30:70 mole ratio) powder.

### Example 5 (BZ20/80)

A catalyst was prepared similarly to Example 1 except that BaZrOx (Ba:Zr=20:80 mole ratio) powder obtained as described below was used instead of BaZrOx (Ba:Zr=48:52 mole ratio) powder in Example 1.

5.11 g of barium acetate was dissolved in 100 g of ion-exchanged water and stirred for 15 minutes or more, thereby preparing a barium acetate aqueous solution. Subsequently, 24.48 g of 25% ammonia aqueous solution and 34.59 g of ammonium carbonate were dissolved in 100 g of ion-exchanged water and stirred for 15 minutes or more, thereby preparing an aqueous solution of ammonia and ammonium carbonate. Further, 54.76 g of zirconyl nitrate aqueous solution was dissolved in 100 g of ion-exchanged water and stirred for 15 minutes or more, thereby preparing a zirconyl nitrate aqueous solution.

Subsequently, the barium acetate aqueous solution and the zirconyl nitrate aqueous solution were mixed, and the resulting mixed aqueous solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1100° C. for 15 hours, thereby obtaining BaZrOx (Ba:Zr=20:80 mole ratio) powder.

### Comparative Example 1 (Pd/(BA+BZ)+Al₂O₃)

50.48 g of barium acetate was dissolved in 200 g of ion-exchanged water and stirred for 15 minutes or more, and then, 20 g of Al₂O₃ powder was added to the aqueous solution and further stirred for 15 minutes or more. Then, the resulting aqueous solution was evaporated to dryness while being heated and stirred with a hot stirrer. The obtained powder was dried at 110° C. overnight, and then calcined at 500° C. for 5 hours using α muffle furnace. Subsequently, the resulting material was ground and classified to have a particle diameter of 75 μm or less, and further fired at 1500° C. for 10 hours using α muffle furnace, thereby obtaining a BaAl₂O₄ powder.

12.66 g of barium acetate was dissolved in 100 g of ion-exchanged water and stirred for 15 minutes or more, thereby preparing a barium acetate aqueous solution. Subsequently, 20.21 g of 25% ammonia aqueous solution and 28.56 g of ammonium carbonate were dissolved in 100 g of ion-exchanged water and stirred for 15 minutes or more, thereby preparing an aqueous solution of ammonia and ammonium carbonate. Further, 33.91 g of zirconyl nitrate aqueous solution was dissolved in 100 g of ion-exchanged water and stirred for 15 minutes or more, thereby preparing a zirconyl nitrate aqueous solution.

Subsequently, the barium acetate aqueous solution and the zirconyl nitrate aqueous solution were mixed, and the resulting mixed aqueous solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1100° C. for 15 hours, thereby obtaining BaZrO₃ (Ba:Zr=50:50 mol %) powder.

Then, the obtained BaAl₂O₄ and BaZrO₃ powders were taken in amounts of 9.0 g and 4.5 g, respectively and mixed, and then ground and classified to be 25 μm or less. 9.0 g of classified powder mixture was immersed in an aqueous solution in which 1.10 g of palladium nitrate aqueous solution (equivalent to 8.2 weight %-Pd) was mixed in 100 g of ion-exchanged water, and then dried at 200° C. while stirring with a hot stirrer. Subsequently, the resulting dried body was further dried at 110° C. overnight, and fired in air at 500° C. for 3 hours, thereby obtaining a Pd-supported BaAl₂O₄-BaZrO₃ powder. 9.00 g of the obtained Pd-supported BaAl₂O₄-BaZrO₃ powder and 1.00 g of Al₂O₃ powder (MI307) were mixed, and ground and classified to be 25 μm or less. Then, the resulting powder was formed by 1-ton isostatic pressing, and classified into pellets of 0.5 mm to 1.0 mm.

### Comparative Example 2 (BaZrYPdOx 1:1.5:0.2:0.09)

9.15 g of barium acetate was dissolved in 100 g of ion-exchanged water and stirred for 15 minutes or more, thereby preparing a barium acetate aqueous solution. Subsequently, 21.40 g of 25% ammonia aqueous solution and 30.24 g of ammonium carbonate were dissolved in 100 g of ion-exchanged water and stirred for 15 minutes or more, thereby preparing an aqueous solution of ammonia and ammonium carbonate. Further, 36.80 g of zirconyl nitrate aqueous solution, 2.75 g of yttrium nitrate hexahydrate, and 4.19 g of palladium nitrate aqueous solution (equivalent to 8.2 weight %-Pd) were dissolved in 100 g of ion-exchanged water and stirred for 15 minutes or more, thereby preparing an aqueous solution of zirconyl nitrate, yttrium nitrate, and palladium nitrate.

Subsequently, the barium acetate aqueous solution and the aqueous solution of zirconyl nitrate, yttrium nitrate, and palladium nitrate were mixed, and the resulting mixed solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1000° C. for 1 hour, thereby obtaining BaZrYPdOx (Ba:Zr:Y:Pd=1:1.5:0.2:0.09 mole ratio) powder. The resulting powder was ground and classified to be 25 μm or less using a mortar and a sieve.

Subsequently, 15.00 g of Al₂O₃—CeO₂—ZrO₂-based composite oxide (Al₂O₃:CeO₂:ZrO₂:La₂O₃:Y₂O₃=30:27:35:4:4 (weight ratio), hereinafter referred to as ACZ) was immersed in a palladium aqueous solution prepared by dissolving 1.83 g of palladium nitrate aqueous solution (equivalent to 8.2 weight %-Pd) in 50 g of ion-exchanged water, and dried at 200° C. while stirring with a hot stirrer. Then, the resulting dried body was further dried at 110° C. overnight, fired in air at 500° C. for 3 hours, thereby obtaining a Pd-supported ACZ catalyst. The resulting catalyst was ground and classified to be 25 μm or less using a mortar and a sieve. Subsequently, 12.0 g of the ground Pd-supported ACZ and 2.0 g of the ground BaZrYPdOx powder were ground and mixed for 5 minutes or more using a mortar. The mixed powder was formed by 1-ton isostatic pressing, and classified using α sieve into pellets with a diameter of 0.5 mm to 1.0 mm, thereby obtaining an initial catalyst.

### Comparative Example 3 (BaZrYPdOx 1:1:0.2:0.09)

A catalyst was prepared similarly to Comparative Example 2 except that BaZrYPdOx (Ba:Zr:Y:Pd=1:1:0.2:0.09 mole ratio) powder obtained as described below was used instead of BaZrYPdOx (Ba:Zr:Y:Pd=1:1.5:0.2:0.09 mole ratio) powder in Comparative Example 2.

11.15 g of barium acetate was dissolved in 100 g of ion-exchanged water and stirred for 15 minutes or more, thereby preparing a barium acetate aqueous solution. Subsequently, 20.13 g of 25% ammonia aqueous solution and 28.45 g of ammonium carbonate were added to 100 g of ion-exchanged water and stirred for 15 minutes or more, thereby preparing an aqueous solution of ammonia and ammonium carbonate. Further, 29.89 g of zirconyl nitrate aqueous solution, 3.35 g of yttrium nitrate hexahydrate, and 5.10 g of palladium nitrate aqueous solution (equivalent to 8.2 weight %-Pd) were mixed in 100 g of ion-exchanged water and stirred for 15 minutes or more, thereby preparing an aqueous solution of zirconyl nitrate, yttrium nitrate, and palladium nitrate.

Subsequently, the barium acetate aqueous solution and the aqueous solution of zirconyl nitrate, yttrium nitrate, and palladium nitrate were mixed, and the resulting mixed aqueous solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1000° C. for 1 hour, thereby obtaining BaZrYPdOx (Ba:Zr:Y:Pd=1:1:0.2:0.09 mole ratio) powder. The resulting powder was ground and classified to be 25 μm or less using a mortar and a sieve.

### Comparative Example 4 (BaZrCeOx 1:0.9:0.1)

A catalyst was prepared similarly to Comparative Example 2 except that BaZrCeOx (Ba:Zr:Ce=1:0.9:0.1 mole ratio) powder obtained as described below was used instead of BaZrYPdOx (Ba:Zr:Y:Pd=1:1.5:0.2:0.09 mole ratio) powder in Comparative Example 2.

12.77 g of barium acetate was dissolved in 100 g of ion-exchanged water and stirred for 15 minutes or more, thereby preparing a barium acetate aqueous solution. Subsequently, 20.4 g of 25% ammonia aqueous solution and 28.45 g of ammonium carbonate were dissolved in 100 g of ion-exchanged water and stirred for 15 minutes or more, thereby preparing an aqueous solution of ammonia and ammonium carbonate. Further, 29.90 g of zirconyl nitrate aqueous solution and 2.17 g of cerium nitrate were dissolved in 100 g of ion-exchanged water and stirred for 15 minutes or more, thereby preparing an aqueous solution of zirconyl nitrate and ceric ammonium nitrate.

Subsequently, the barium acetate aqueous solution and the aqueous solution of zirconyl nitrate and ceric ammonium nitrate were mixed, and the resulting mixed aqueous solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1000° C. for 10 hours, thereby obtaining BaZrCeOx (Ba:Zr:Ce=1:0.9:0.1 mole ratio) powder.

### Comparative Example 5 (BZ55/45: Ba Rich)

A catalyst was prepared similarly to Comparative Example 2 except that BaZrOx (Ba:Zr=55:45 mole ratio) powder obtained as described below was used instead of BaZrYPdOx (Ba:Zr:Y:Pd=1:1.5:0.2:0.09 mole ratio) powder in Comparative Example 2.

14.05 g of barium acetate was dissolved in 100 g of ion-exchanged water and stirred for 15 minutes or more, thereby preparing a barium acetate aqueous solution. Subsequently, 19.72 g of 25% ammonia aqueous solution and 27.87 g of ammonium carbonate were added to 100 g of ion-exchanged water and stirred for 15 minutes or more, thereby preparing an aqueous solution of ammonia and ammonium carbonate. Further, 30.81 g of zirconyl nitrate aqueous solution was mixed in 100 g of ion-exchanged water and stirred for 15 minutes or more, thereby preparing a zirconyl nitrate aqueous solution.

Subsequently, the barium acetate aqueous solution and the zirconyl nitrate aqueous solution were mixed, and the resulting mixed solution was added dropwise into the aqueous solution of ammonia and ammonium carbonate under stirring with a stirrer, followed by stirring for 30 minutes or more. The resulting sol was dried at 150° C. for 8 hours, then calcined at 400° C. for 5 hours, and fired in air at 1100° C. for 15 hours, thereby obtaining BaZrOx (Ba:Zr=55:45 mole ratio) powder.

### Comparative Example 6 (without Ba/ZLY Only)

A catalyst was prepared similarly to Comparative Example 2 except that ZrO₂—La₂O₃—Y₂O₃(ZrO₂:La₂O₃:Y₂O₃=84:6:10 weight ratio) powder obtained as described below was used instead of BaZrYPdOx (Ba:Zr:Y:Pd=1:1.5:0.2:0.09 mole ratio) powder in Comparative Example 2.

ZrO₂—La₂O₃—Y₂O₃(ZrO₂:La₂O₃:Y₂O₃=84:6:10 weight ratio) was fired in air at 1100° C. for 15 hours.

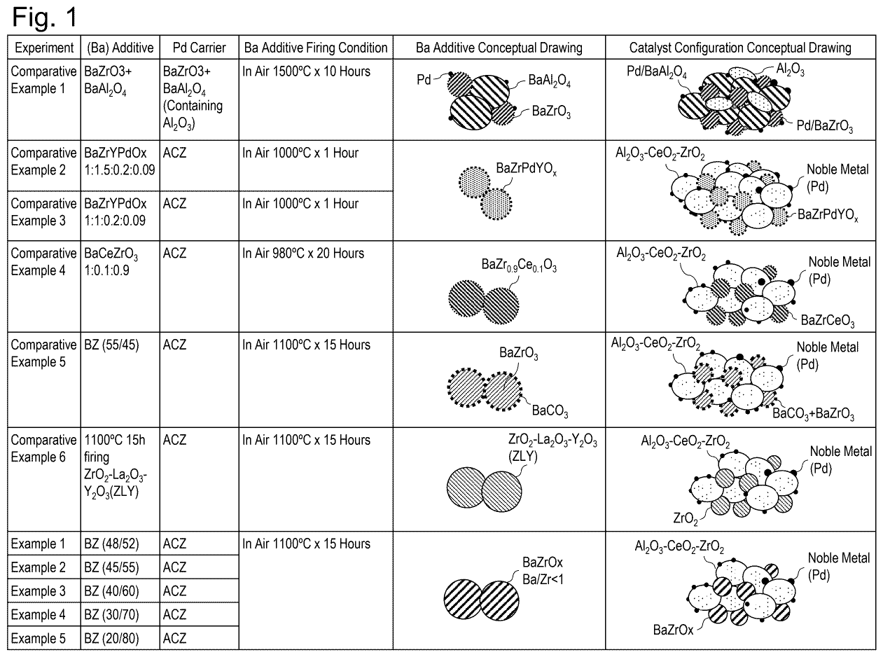

FIG. 1 is a drawing illustrating configurations of three-way catalysts including schematic diagrams for comparing three-way catalysts of Comparative Examples 1 to 6 and three-way catalysts of Examples 1 to 5.

### 2. Evaluation of Three-Way Catalyst: X-Ray Diffraction Test

Diffraction lines of the powders of the respective Ba additives used in the comparative examples and examples were measured under the conditions of Cu-ka ray 20=200 to 60°, 0.02°/step, scan rate 5°/min, 40V-40A using α powder X-ray diffraction apparatus (manufactured by Rigaku Holdings Corporation, RINT-ULTIMA IV). Pattern fitting was performed for all the obtained diffraction lines using JADE-Pro (manufactured by Lightstone Corp.), thereby identifying crystalline phases and calculating the contents of BaCO₃ and BaO phases.

### Catalyst Durability Test

3.0 g of the initial catalyst pellets having the diameter of 0.5 mm to 1.0 mm in comparative examples and examples were packed into a quartz reactor tube having an inner diameter of 13 mm, and a rich gas and a lean gas described in a table below were alternately flowed every five minutes at a flow rate of 500 cc/min, thus a high-temperature durability test was performed at 1050° C. for 25 hours.

TABLE 1
Composition of Flowed Gas Used for Catalyst Durability Test

| | CO₂ | O₂ | H₂ | H₂O | |
|---|---|---|---|---|---|
| | (Volume %) | (Volume %) | (Volume %) | (Volume %) | N₂ |
| Rich | 10 | 0.0 | 2.0 | 3 | Balance |
| Lean | 10 | 1.0 | 0.0 | 3 | Balance |

### Evaluation of Oxygen Storage Capacity (OSC) of Catalyst

1.0 g of the catalyst after the catalyst durability test was sealed in a sample holder with a diameter of 16 mm and set in a fixed-bed flow reactor device for catalyst activity evaluation. The catalyst was pretreated at 500° C. by alternating 2 vol % CO gas and 1 vol % O₂ gas every 3 minutes, and subsequently, the amount of CO₂ generated upon switching the gas from lean to rich at 400° C. was measured to evaluate the oxygen storage capacity (OSC) activity. The pretreatment and evaluation gases were as follows.

TABLE 2
Composition of Model Gas Used for Oxygen
Storage Capacity (OSC) Evaluation

| | O₂ (Volume %) | CO (Volume %) | N₂ |
|---|---|---|---|
| Lean | 1.0 | 0.0 | Balance |
| Rich | 0 | 2.0 | Balance |

### Evaluation of Purification Activity (Temperature Characteristic) of Catalyst

1.0 g of the catalyst after the catalyst durability test was sealed in a quartz sample holder with a diameter of 16 mm and set in a fixed-bed flow reactor device for catalyst activity evaluation (BEST INSTRUMENTS CO., Ltd., CATA5000). The catalyst was pretreated at 600° C. by alternating the pretreatment gases (rich gas and lean gas) every 10 seconds, then cooled, and an evaluation gas was flowed while raising the temperature from 100° C. to 550° C. The inlet gas temperatures at which the HC and NOx conversion rates reached 50% were evaluated as HC-T50 and NO-T50, respectively. The pretreatment and evaluation gases were as follows.

TABLE 3
Composition of Model Gas Used for Purification Activity
(Temperature Characteristic) Evaluation

| | CO₂ | O₂ | CO | NO | C₃H₆ | H₂O | |
|---|---|---|---|---|---|---|---|
| | (Volume %) | (Volume %) | (Volume %) | (ppm) | (ppmC) | (Volume %) | N₂ |
| Pretreatment | 10 | 0.5 | 0.92 | 3200 | 3000 | 3 | Balance |
| Rich Gas | | | | | | | |
| Pretreatment | 10 | 0.7 | 0.52 | 3200 | 3000 | 3 | Balance |
| Lean Gas | | | | | | | |
| Evaluation Gas | 10 | 0.52 | 0.52 | 3200 | 3000 | 3 | Balance |

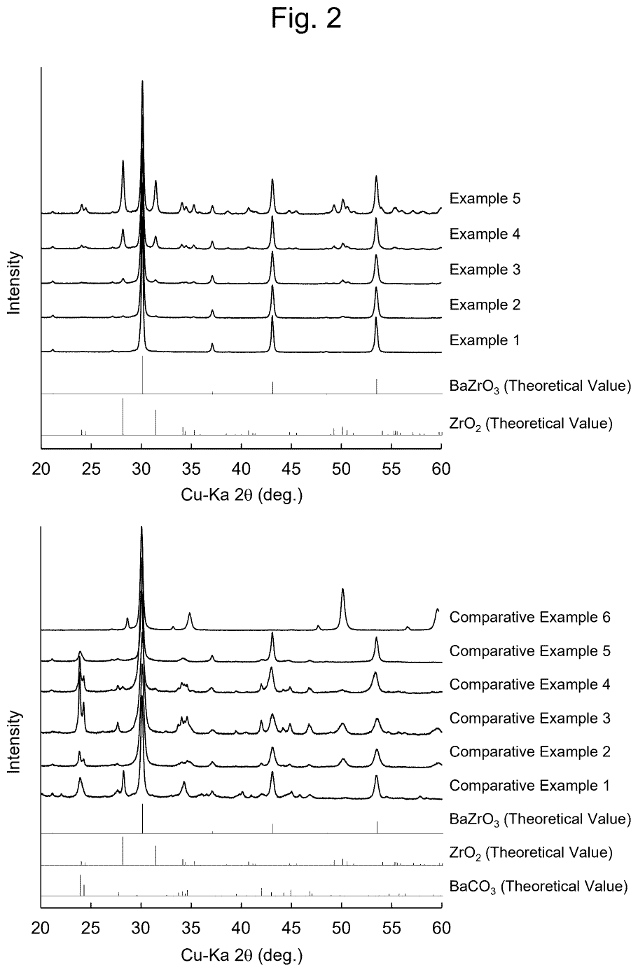

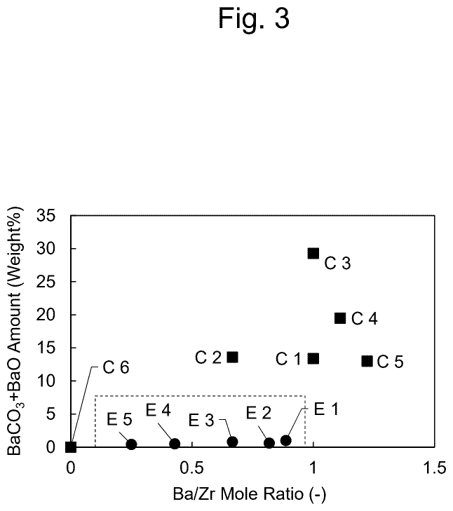

Table 4 summarizes the compositions of the examples and comparative examples. FIG. 2 illustrates powder X-ray diffraction patterns of respective Ba additives used in the examples and the comparative examples. Further, FIG. 3 illustrates a relation between a Ba/Zr mole ratio and an amount of barium carbonate and barium oxide in the three-way catalysts of the examples and the comparative examples.

TABLE 4
List of Example and Comparative Example

| | | | | | | Preparation Composition | | | |
|---|---|---|---|---|---|---|---|---|---|
| | | Ba Additive Preparation Composition | | | | after Mixing Pd Catalyst | | | |
| | | | | Ba/Zr | BC + | | Pd | CeO₂ | BaO |
| Sample | | BaO | ZrO₂ | Mole | BaO | Pd | Amount | Amount | Amount |
| Experiment | Ba Additive | Weight % | Weight % | Ratio | Weight % | Carrier | Weight % | Weight % | Weight % |
| Comparative | BaAl₂O₄ + | 58.52 | 14.85 | 1 | 13.4 | BZ + BA | 0.90 | 0 | 52.67 |
| Example 1 | BaZrO₃ | | | | | | | | |
| Comparative | BaZrYPdOx | 41.41 | 49.9 | 0.67 | 13.6 | ACZ | 0.86 | 25.71 | 5.92 |
| Example 2 | | | | | | | | | |
| Comparative | BaZrYPdOx | 49.67 | 39.91 | 1 | 29.3 | ACZ | 0.86 | 25.71 | 7.10 |
| Example 3 | | | | | | | | | |
| Comparative | BaCeZrO₃ | 54.48 | 39.39 | 1.11 | 19.5 | ACZ | 0.86 | 26.59 | 7.78 |
| Example 4 | | | | | | | | | |
| Comparative | BaZrOx (55/45) | 60.33 | 39.66 | 1.22 | 13 | ACZ | 0.86 | 25.71 | 8.62 |
| Example 5 | | | | | | | | | |
| Comparative | ZrO₂ − La₂O₃ − | 0 | 84.00 | 0 | 0 | ACZ | 0.86 | 25.71 | 0 |
| Example 6 | Y₂O₃ | | | | | | | | |
| Example 1 | BaZrOx (48/52) | 53.46 | 46.53 | 0.89 | 1 | ACZ | 0.86 | 25.71 | 7.64 |
| Example 2 | BaZrOx (45/55) | 50.45 | 49.55 | 0.82 | 0.6 | ACZ | 0.86 | 25.71 | 7.14 |
| Example 3 | BaZrOx (40/60) | 45.34 | 54.66 | 0.67 | 0.8 | ACZ | 0.86 | 25.71 | 6.43 |
| Example 4 | BaZrOx (30/70) | 34.78 | 65.22 | 0.43 | 0.5 | ACZ | 0.86 | 25.71 | 4.86 |
| Example 5 | BaZrOx (20/80) | 23.73 | 76.26 | 0.25 | 0.4 | ACZ | 0.86 | 25.71 | 3.39 |

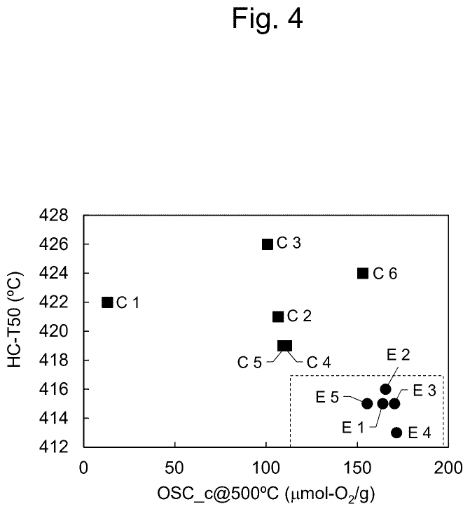

Table 5 summarizes the activity evaluation results of the examples and the comparative examples. FIG. 4 illustrates a relation between an OSC amount at 500° C. and HC-T50 in the three-way catalysts of the examples and the comparative examples. Here, the OSC amount is satisfactory when the value is large, and HC-T50 and NO-T50 are satisfactory when the value is small.

TABLE 5
Example and Comparative Example Activation Evaluation Result

| | OSC Amount | OSC Amount | HC- | NO- |
|---|---|---|---|---|
| | @500° C. | @400° C. | T50 | T50 |
| Experiment | (μmol-O₂/g) | (μmol-O₂/g) | (° C.) | (° C.) |
| Example 1 | 163.95 | 47.24 | 415 | 429 |
| Example 2 | 165.50 | 50.78 | 416 | 430 |
| Example 3 | 170.40 | 53.53 | 415 | 429 |
| Example 4 | 171.51 | 54.84 | 413 | 426 |
| Example 5 | 155.40 | 45.37 | 415 | 428 |
| Comparative Example 1 | 12.95 | 3.82 | 422 | 442 |
| Comparative Example 2 | 106.58 | 23.15 | 421 | 438 |
| Comparative Example 3 | 100.76 | 23.67 | 426 | 446 |
| Comparative Example 4 | 109.22 | 22.33 | 419 | 435 |
| Comparative Example 5 | 111.10 | 22.79 | 419 | 437 |
| Comparative Example 6 | 152.97 | 45.82 | 424 | 441 |

Adding Ba to the Pd-based three-way catalyst suppresses HC poisoning of Pd, and improves the low-temperature activity of the three-way catalyst. However, one of the conventional problems (objects to be achieved) on the Ba additive is that CeO₂—ZrO₂ solid solution (CZ) having the oxygen storage capacity (OSC) required of the three-way catalyst undergoes a solid-state reaction with Ba, resulting in a decrease in the OSC performance after the durability test. Furthermore, free barium carbonate promotes a reduction in the specific surface area of the carrier and/or substrate and the covering of noble metal, thus reducing the purification activity in some cases.

In some aspects of the present disclosure, by using α BaZrOx-based composite oxide as a Ba additive, the three-way catalyst that is thermally stable compared with BaCO₃, BaO, and BaSO₄, which are the conventionally used Ba additives, less likely to form BaCO₃ even after the heat resistance test, and has the OSC performance and the purification activity in a compatible manner was able to be obtained. In the BaZrOx-based composite oxide, by adjusting the composition and structure so as to become 0.1<Ba/Zr<1, it was found that the stability of the perovskite structure increases compared with a BaZrMO₃-based composite oxide having the similar structure, and generation of unstable BaCO₃ and BaO can be suppressed. Thus, the more stable Ba additive was able to be obtained.

A perovskite oxide consisting of Ba and Zr has a tolerance factor, which indicates the stability of perovskite structure, of 1.006, and has a highly stable perovskite structure. However, when an additive is introduced, the tolerance factor significantly deviates from 1, and the stability decreases. When the Ba component becomes excess even slightly, unstable free Ba component, such as barium carbonate, is generated. According to some aspects of the present disclosure, by slightly decreasing the Ba/Zr ratio from 1.0, the reaction with ZrO₂ easily occurs even when free Ba is generated. As a result, the generation of free Ba component that promotes the deterioration of the three-way catalyst was suppressed, and the stability of the Ba additive was able to be improved. By mixing the BaZrOx composite oxide with 0.1<Ba/Zr<1 and the Pd catalyst comprising the OSC material, the exhaust gas purification catalyst excellent in OSC performance and purification activity was able to be achieved.

In some aspects of the present disclosure, by using BaZrOx that is a stable Ba additive, the generation of BaO and BaCO₃ that is an unstable Ba phase was suppressed under a high-temperature atmosphere in which both H₂O and CO₂ are present, and consequently, the degradation of OSC was suppressed.

In some aspects of the present disclosure, by using BaZrOx that is a stable Ba additive, the generation of BaO and BaCO₃ that is an unstable Ba phase was suppressed under a high-temperature atmosphere in which both H₂O and CO₂ are present, the reduction in the specific surface area of the carrier and/or substrate and the covering of noble metal were suppressed, and consequently, the degradation of purification activity was suppressed.

All publications, patents and patent applications cited in the present description are herein incorporated by reference as they are.

What is claimed is:

1. A three-way catalyst comprising:
a noble metal;
an OSC material; and
an oxide solid solution comprising barium and zirconium,
wherein the noble metal is supported on the OSC material,
wherein a mole ratio of barium to zirconium (Ba:Zr) in the oxide solid solution is in a range of 20:80 to 49:51, and
wherein a content of barium carbonate and barium oxide in the oxide solid solution is 2 weight % or less with respect to a total weight of the oxide solid solution.

2. The three-way catalyst according to claim 1,
wherein the oxide solid solution is a perovskite-type oxide.

3. The three-way catalyst according to claim 2,
wherein the mole ratio of barium to zirconium (Ba:Zr) in the oxide solid solution is in a range of 30:70 to 49:51.

4. The three-way catalyst according to claim 1,
wherein the content of barium carbonate and barium oxide in the oxide solid solution is 1 weight % or less.

5. A method for manufacturing a three-way catalyst, comprising:
(i) preparing an oxide solid solution comprising barium and zirconium by coprecipitating barium and zirconium from an aqueous solution comprising a barium compound and a zirconium compound to obtain a precipitate and firing the precipitate at a temperature from 1000° C. to 1400° C., wherein a mole ratio of barium to zirconium (Ba:Zr) in the oxide solid solution is adjusted in a range of 20:80 to 49:51;
(ii) preparing a noble metal-supported OSC material by mixing an aqueous solution containing a noble metal and an OSC material to obtain a mixture and drying the mixture; and
(iii) producing a three-way catalyst by mixing the oxide solid solution prepared in (i) and the noble metal-supported OSC material prepared in (ii).
